(19) United States
(12) Patent Application Publication
(10) Pub. No.: US 2023/0060509 A1
(43) Pub. Date: Mar. 2, 2023

(54) POSITIVE ELECTRODE FOR LITHIUM-ION BATTERY AND PRODUCTION METHOD THEREOF

(71) Applicant: APB CORPORATION, Tokyo (JP)

(72) Inventors: Masatoshi OKURA, Kyoto (JP); Kenichi KAWAKITA, Kyoto (JP); Yusuke NAKASHIMA, Kyoto (JP); Hideaki HORIE, Tokyo (JP)

(73) Assignee: APB CORPORATION, Tokyo (JP)

(21) Appl. No.: 17/795,685

(22) PCT Filed: Feb. 3, 2021
(86) PCT No.: PCT/JP2021/003862

§ 371 Date: Jul. 27, 2022

(30) Foreign Application Priority Data
Feb. 3, 2020 (JP) 2020-016237
Feb. 4, 2020 (JP) 2020-017028

(51) Int. Cl. H01M 4/62

(52) U.S. Cl. CPC H01M 4/622; H01M 2004/028

(57) ABSTRACT

A positive electrode for a lithium-ion battery comprising a current collector and a positive electrode composition layer disposed on a surface of the current collector, wherein the current collector and the positive electrode composition layer are not adhered to each other, the positive electrode composition layer contains coated positive electrode active material particles in which at least a part of a surface of each positive electrode active material particle is coated with a coating layer containing a polymer compound (A), and a conductive auxiliary agent, the polymer compound (A) is any one of a copolymer (A1) having methacrylic acid, lauryl methacrylate and 1,6-hexanediol dimethacrylate as constituent monomers, a copolymer (A2) having isobornyl methacrylate and 1,6-hexanediol dimethacrylate as constituent monomers, or a copolymer (A3) having lauryl methacrylate, 2-ethylhexyl methacrylate and 1,6-hexanediol dimethacrylate as constituent monomers, the weight proportion of 1,6-hexanediol dimethacrylate contained in the constituent monomers of the copolymer is 0.2 to 1% by weight based on the total weight of the constituent monomers of the copolymer, and the weight average molecular weight of the polymer compound (A) is 300,000 or less.

### TECHNICAL FIELD

The present invention relates to a positive electrode for a lithium-ion battery and a production method thereof.

### BACKGROUND ART

Lithium-ion batteries have been widely used in various applications in recent years as secondary batteries capable of achieving high energy density and high output density. Further, with the expansion of applications, demands for increasing the capacity of lithium-ion batteries has been increased.

One of the methods for increasing the capacity of the lithium-ion battery is a method for increasing the area of an electrode. However, in general, increase in the area of the electrode of a lithium-ion battery causes greater influence of the volume change of the electrode active material layer along with charging and discharging, and the electrode active material layer is liable to self-destruct or peel off from the surface of the current collector. Therefore, it has been difficult to improve the cycle characteristics.

PTL1 discloses a method of disposing a pressure relaxation layer between the current collector and the electrode active material layer in order to solve the problem associated with the volume change of the electrode active material layer along with charging and discharging. Further, PTL2 discloses a method for alleviating the volume change of an electrode by coating the surface of the electrode active material with a resin that has a liquid absorption rate of at least 10% when immersed in an electrolyte solution and a tensile breaking elongation rate of at least 10% in the saturated liquid absorption state.

### CITATION LIST

### Patent Literature

PTL1: Japanese Patent Laid-Open No. 2018-101624

PTL2: International Publication No. 2015/5117

### SUMMARY OF INVENTION

### Technical Problem

However, it cannot be said that the methods disclosed in PTL1 and PTL2 are sufficiently effective for a large-area electrode which is greatly affected by the volume change of the electrode active material layer. In addition, there has been room for further improvement from the viewpoint of energy density and cycle characteristics.

Specifically, in view of the foregoing, the present invention is made and the purpose thereof is to provide a positive electrode for a lithium-ion battery that has excellent energy density and cycle characteristics and the area thereof can be increased.

### Solution to Problem

The present inventors have arrived at the present invention as a result of earnest examination to solve the problems above. Specifically, the present invention relates to a positive electrode for a lithium-ion battery comprising a current collector and a positive electrode composition layer disposed on a surface of the current collector, wherein the current collector and the positive electrode composition layer are not adhered to each other, the positive electrode composition layer contains coated positive electrode active material particles in which at least a part of a surface of each positive electrode active material particle is coated with a coating layer containing a polymer compound (A), and a conductive auxiliary agent, the polymer compound (A) is any one of: a copolymer (A1) having methacrylic acid, lauryl methacrylate and 1,6-hexanediol dimethacrylate as constituent monomers; a copolymer (A2) having isobornyl methacrylate and 1,6-hexanediol dimethacrylate as constituent monomers; or a copolymer (A3) having lauryl methacrylate, 2-ethylhexyl methacrylate and 1,6-hexanediol dimethacrylate as constituent monomers, the weight proportion of 1,6-hexanediol dimethacrylate contained in the constituent monomers of the copolymer is 0.2 to 1% by weight based on the total weight of the constituent monomers of the copolymer, and the weight average molecular weight of the polymer compound (A) is 300,000 or less, and also relates to a production method for a positive electrode for a lithium-ion battery comprising a current collector and a positive electrode composition layer disposed on a surface of the current collector, the method comprising the steps of: preparing a positive electrode composition layer by compression-molding a positive electrode composition containing coated positive electrode active material particles in which at least a part of a surface of each positive electrode active material particle is coated with is coated with a coating layer containing a polymer compound (A), and a conductive auxiliary agent; and relocating the positive electrode composition layer on the current collector, wherein the polymer compound (A) is any one of: a copolymer (A1) having methacrylic acid, lauryl methacrylate and 1,6-hexanediol dimethacrylate as constituent monomers; a copolymer (A2) having isobornyl methacrylate and 1,6-hexanediol dimethacrylate as constituent monomers; or a copolymer (A3) having lauryl methacrylate, 2-ethylhexyl methacrylate and 1,6-hexanediol dimethacrylate as constituent monomers, the weight proportion of 1,6-hexanediol dimethacrylate contained in the constituent monomers of the copolymer is 0.2 to 1% by weight based on the total weight of the constituent monomers of the copolymer, and the weight average molecular weight of the polymer compound (A) is 300,000 or less.

### Advantageous Effects of Invention

According to the present invention, it is possible to obtain a positive electrode for a lithium-ion battery having a high energy density and excellent cycle characteristics, and the area thereof can be increased.

### DESCRIPTION OF EMBODIMENTS

Hereinafter, the present invention will be described in detail.

In the present specification, the lithium-ion battery in a case of being described shall include a concept of a lithium-ion secondary battery as well.

A positive electrode for a lithium-ion battery of the present invention is a positive electrode for a lithium-ion battery comprising a current collector and a positive electrode composition layer disposed on a surface of the current collector, wherein the current collector and the positive electrode composition layer are not adhered to each other, the positive electrode composition layer contains coated positive electrode active material particles in which at least a part of a surface of each positive electrode active material particle is coated with a coating layer containing a polymer compound (A), and a conductive auxiliary agent, the polymer compound (A) is any one of: a copolymer (A1) having methacrylic acid, lauryl methacrylate and 1,6-hexanediol dimethacrylate as constituent monomers; a copolymer (A2) having isobornyl methacrylate and 1,6-hexanediol dimethacrylate as constituent monomers; or a copolymer (A3) having lauryl methacrylate, 2-ethylhexyl methacrylate and 1,6-hexanediol dimethacrylate as constituent monomers, the weight proportion of 1,6-hexanediol dimethacrylate contained in the constituent monomers of the copolymer is 0.2 to 1% by weight based on the total weight of the constituent monomers of the copolymer, and the weight average molecular weight of the polymer compound (A) is 300,000 or less.

The positive electrode for a lithium-ion battery has a current collector.

Examples of material constituting the current collector include metal materials such as copper, aluminum, titanium, stainless steel, nickel and alloys thereof, calcined carbon, conductive polymer material, conductive glass and the like.

Of these materials, a conductive polymer material is preferable from the viewpoint of weight reduction, corrosion resistance, and high conductivity.

The shape of the current collector is not particularly limited, and may be a sheet-shaped current collector made of the above materials. Further, the current collector may be a deposited layer made of fine particles composed of the above materials.

The thickness of the current collector is not particularly limited, but is preferably 50 to 500 μm.

The current collector is preferably a resin current collector made of a conductive polymer material.

As the conductive polymer material constituting the resin current collector, for example, a conductive polymer or a resin to which a conductive agent is added, if necessary, can be used.

Examples of the conductive agent constituting the conductive polymer material include metal-based conductive auxiliary agents [aluminum, stainless steel (SUS), silver, gold, copper, titanium and alloys containing these metals], carbon-based conductive agents [graphite and carbon black (acetylene black, Ketjen black, furnace black, channel black, thermal lamp black, etc.), etc.], and mixtures thereof, etc.

One kind of these conductive auxiliary agents may be used alone, or two or more kinds thereof may be used in combination.

From the viewpoint of electrical stability, aluminum, stainless steel, silver, gold, copper, titanium, a carbon-based conductive auxiliary agent, or a mixture thereof is preferable, silver, gold, aluminum, stainless steel, or a carbon-based conductive auxiliary agent is more preferable, and a carbon-based conductive auxiliary agent is particularly preferable.

Further, these conductive auxiliary agents may be those obtained by coating a conductive material [preferably, a metallic conductive material among materials of the conductive auxiliary agent described above] around a particle-based ceramic material or a resin material with plating or the like.

The average particle size of the conductive auxiliary agent is not particularly limited; however, it is preferably 0.01 to 10 μm, more preferably 0.02 to 5 μm, and still more preferably 0.03 to 1 μm, from the viewpoint of the electrical characteristics of the battery. The “particle size” herein means the maximum distance L among the distances between any two points on the contour line of the conductive auxiliary agent. As the value of the “average particle size”, the average value of the particle sizes of the particles observed in several to several tens of visual fields using an observation means such as a scanning electron microscope (SEM) or a transmission electron microscope (TEM) shall be adopted.

The shape (the form) of the conductive auxiliary agent is not limited to the particle form, may be a form other than the particle form, and may be a form practically applied as a so-called filler-based conductive auxiliary agent such as carbon nanotubes.

The conductive auxiliary agent may be a conductive fiber of which the shape is fibrous.

Examples of the conductive fiber include a carbon fiber such as a PAN-based carbon fibers or a pitch-based carbon fiber, a conductive fiber obtained by uniformly dispersing a metal having good conductivity or graphite in the synthetic fiber, a metal fiber obtained by making a metal such as stainless steel into a fiber, a conductive fiber obtained by coating a surface of an organic fiber with a metal, and a conductive fiber obtained by coating a surface of an organic fiber with a resin containing a conductive substance. Among these conductive fibers, a carbon fiber is preferable. In addition, a polypropylene resin in which graphene is kneaded is also preferable.

In a case where the conductive auxiliary agent is a conductive fiber, the average fiber diameter thereof is preferably 0.1 to 20 μm.

The content of a conductive auxiliary agent is preferably 1 to 79 wt %, more preferably 2 to 30 wt %, and still preferably 5 to 25 wt %, from the viewpoint of dispersibility of the conductive auxiliary agent.

Examples of resins constituting the conductive polymer material include polyethylene, polypropylene, polymethylpentene, polycycloolefin, polyethylene terephthalate, polyether nitrile, polytetrafluoroethylene, styrene butadiene rubber, polyacrylonitrile, polymethyl acrylate, polymethyl methacrylate. polyfluoride vinylidene, epoxy resin, silicone resin or a mixture thereof and the like.

From the viewpoint of electrical stability, polyethylene, polypropylene, polymethylpentene and polycycloolefin are preferable, and polyethylene, polypropylene and polymethylpentene are more preferable.

The content of resin constituting the conductive polymer material is preferably 20 to 98% by weight, more preferably 40 to 95% by weight, and still preferably 60 to 92% by weight, based on the weight of the resin current collector from the viewpoint of resin strength.

The resin current collector described above can be produced, for example, by the following method.

First, a material for a resin current collector is obtained by mixing a resin, a conductive auxiliary agent and, if necessary, other components.

Examples of the mixing method include a method of obtaining a master batch of conductive filler and then further mixing with a resin, a method of using a master batch of a resin, a conductive auxiliary agent and, if necessary, other components, and a method of mixing all raw materials collectively, and for the mixing, a suitable known mixer for mixing pellet-like or powder-like components, for example, a kneader, an internal mixer, a Banbury mixer and a roll can be used.

There is no particular limitation on the order of addition of each component during mixing. The obtained mixture may be further pelletized by a pelletizer, or powdered.

Forming the obtained material for the current collector into, for example, a film, whereby the above resin current collector can be obtained. Examples of the method for forming into a shape of a film include the T-die method, inflation method, calendering method, and other known film forming methods. The above resin current collector can also be obtained by molding methods other than film molding.

The positive electrode for a lithium-ion battery of the present invention has a positive electrode composition layer.

The positive electrode composition layer is not adhered to the current collector.

The above positive electrode composition layer contains coated positive electrode active material particles in which at least a part of a surface of each positive electrode active material particle is coated with a coating layer containing a polymer compound (A), and a conductive auxiliary agent.

Examples of the above positive electrode active material particles include a composite oxide of lithium and a transition metal {a composite oxide having one kind of transition metal (LiCoO₂, LiNiO₂, LiAlMnO₄, LiMnO₂, LiMn₂O₄, or the like), a composite oxide having two kinds of transition metal elements (for example, LiFeMnO₄, LiNi₁₋ₓCoxO2, LiMn_{1-y}CoyO₂, LiNi_{1/3}Co_{1/3}Al_{1/3}O₂, and LiNi_{0.8}Co_{0.15}Al_{0.05}O₂), a composite oxide having three or more kinds of metal elements [for example, LiMₐM′_{b}M″_{c}O₂ (where M, M′, and M″ are transition metal elements different each other and satisfy a+b+c=1, and one example is LiNi_{1/3}Mn_{1/3}Co_{1/3}O₂)], or the like}, a lithium-containing transition metal phosphate (for example, LiFePO₄, LiCoPO₄, LiMnPO₄, or LiNiPO₄), a transition metal oxide (for example, MnO₂ and V₂O₅), a transition metal sulfide (for example, MoS₂ or TiS₂), and a conductive macromolecule (for example, polyaniline, polypyrrole, polythiophene, polyacetylene, poly-p-phenylene, or polyvinyl carbazole). Two or more thereof may be used in combination.

Here, the lithium-containing transition metal phosphate may be one in which a part of transition metal sites is substituted with another transition metal.

An average particle size of the positive electrode active material particles is preferably 0.01 to 100 more preferably 0.1 to 35 and still more preferably 2 to 30 from the viewpoint of battery characteristics.

The volume average particle size of the positive electrode active material particles means the particle size (Dv50) at an integrated value of 50% in the particle size distribution obtained by the microtrack method (the laser diffraction/scattering method). The microtrack method is a method of determining a particle size distribution by using scattered light obtained by irradiating particles with laser light. A laser diffraction/scattering type particle size distribution measurement device [MICROTRAC available from MicrotracBEL Corp.] can be used for measuring the volume average particle size.

The above polymer compound (A) is any one of a copolymer (A1) having methacrylic acid, lauryl methacrylate and 1,6-hexanediol dimethacrylate as constituent monomers, a copolymer (A2) having isobornyl methacrylate and 1,6-hexanediol dimethacrylate as constituent monomers, or a copolymer (A3) having lauryl methacrylate, 2-ethylhexyl methacrylate and 1,6-hexanediol dimethacrylate as constituent monomers.

The weight proportion of 1,6-hexanediol dimethacrylate contained in the constituent monomers of the above copolymers (A1), (A2) and (A3) is 0.2 to 1% by weight based on the total weight of the constituent monomers of the copolymer. If the weight percentage of 1,6-hexanediol dimethacrylate in the above copolymers (A1), (A2) and (A3) is less than 0.2% by weight, the resin swells due to electrolyte solution in batteries, and thus is not exhibit sufficient strength to fix the position of the positive electrode active material particles in the positive electrode composition layer; if the weight percentage exceeds 1% by weight, the adhesiveness of the resin deteriorates, and thus cannot exhibit sufficient strength to fix the position of the positive electrode active material particles in the positive electrode composition layer.

The weight proportion of 1,6-hexanediol dimethacrylate contained in the constituent monomers of the above copolymers (A1), (A2) and (A3) can be measured by a method such that a copolymer is dissolved in a supercritical fluid and the obtained oligomer component is analyzed by a gas chromatography mass analysis (GC-MS) method.

A weight average molecular weight [hereinafter, abbreviated as Mw: the measurement is based on the gel permeation chromatography (GPC) method described later] of the above polymer compound (A) is 300,000 or less. If Mw of the above polymer compound (A) exceeds 300,000, the viscosity of the resin solution increases too much, and thus a good coating cannot be obtained.

Mw of the polymer compound (A) is preferably 200,000 or less, and more preferably 150,000 or less. Mw of the polymer compound (A) is preferably 30,000 or more, and more preferably 60,000 or more.

The measurement conditions of Mw by GPC in the present invention are as follows.

Device: high temperature gel permeation chromatograph [“Alliance GPC V2000”, available from Waters Corporation] Solvent: ortho-dichlorobenzene
Standard substance: polystyrene
Sample concentration: 3 mg/ml
Column solid phase: PLgel 10 MIXED-B, two columns connected in series (Polymer Laboratories Limited)
Column temperature: 135° C.

The above polymer compound (A) can be produced by a known polymerization method (mass polymerization, solution polymerization, emulsification polymerization, suspension polymerization, etc.) using known polymerization initiators {azo-based initiators [2,2′-azobis(2-methylpropionitrile), 2,2′-azobis(2,4-dimethylvaleronitrile, etc.)], peroxide-based initiators (benzoyl peroxide, di-t-butyl peroxide, lauryl peroxide, etc.)}.

The amount of the polymerization initiator used is preferably 0.01 to 5% by weight, more preferably 0.05 to 2% by weight, further preferably 0.1 to 1.5% by weight based on the total weight of the monomers, from the viewpoint of adjusting Mw to a preferable range, and while the polymerization temperature and polymerization time are adjusted depending on the type of polymerization initiator and the like, the polymerization temperature is preferably −5 to 150° C. (more preferably 30 to 120° C.), and the reaction time is preferably 0.1 to 50 hours (more preferably 2 to 24 hours).

Examples of the solvent used in the case of solution polymerization include esters (C2-C8, such as ethyl acetate and butyl acetate), alcohols (C1-C8, such as methanol, ethanol and octanol), and hydrocarbons (C4-C8, such as n-butane, cyclohexane and toluene) and ketones (C3-C9, such as methyl ethyl ketone). From the viewpoint of adjusting the molecular weight to a preferable range, the amount used is preferably 5 to 900% by weight, more preferably 10 to 400% by weight, and particularly preferably 30 to 300% by weight based on the total weight of the monomers, and the monomer concentration is preferably 10 to 95% by weight, more preferably 20 to 90% by weight, and particularly preferably 30 to 80% by weight.

Examples of the dispersion medium in emulsification polymerization and suspension polymerization include water, alcohol (such as ethanol), ester (such as ethyl propionate), light naphtha, etc., and examples of the emulsifier include higher fatty acid (C10-C24) metal salt (such as sodium oleate and sodium stearate), higher alcohol (C10-C24) sulfate ester metal salt (such as sodium lauryl sulfate), ethoxylated tetramethyldecinediol, sodium sulfoethyl methacrylate, dimethylaminomethyl methacrylate, etc. Further, polyvinyl alcohol, polyvinyl pyrrolidone, etc. may be added as stabilizers.

The monomer concentration of the solution in solution polymerization and the monomer concentration of the dispersion in emulsion polymerization and suspension polymerization are preferably 5 to 95% by weight, more preferably 10 to 90% by weight, still more preferably 15 to 85% by weight. The amount of the polymerization initiator used is preferably 0.01 to 5% by weight, more preferably 0.05 to 2% by weight, based on the total weight of the monomer.

For polymerization, known chain transfer agents such as mercapto compounds (dodecyl mercaptan, n-butyl mercaptan, etc.) and/or halogenated hydrocarbons (carbon tetrachloride, carbon tetrabromide, benzyl chloride, etc.) can be used.

In the coated positive electrode active material particles, at least a part of a surface of each positive electrode active material particle is coated with a coating layer containing a polymer compound (A). The coating layer may further contain a conductive material, if necessary.

The weight proportion of the above polymer compound (A) to the weight of the above positive electrode active material particles is not particularly limited, but is preferably 0.1 to 10% by weight from the viewpoint of fixing the positions of the coated positive electrode active material particles, and from the viewpoint of moldability of the positive electrode composition layer.

For example, the above coated positive electrode active material particles can be obtained as follows: while the above positive electrode active material is stirred at 30 to 50 rpm in a universal mixer, a resin solution containing the above polymer compound (A) is added dropwise thereto over 1 to 90 minutes; the conductive auxiliary agent is further added if necessary; while the mixture is stirred, the temperature is raised to 50 to 200° C., and the pressure is reduced to 0.007 to 0.04 MPa; and the mixture is then kept in this state for 10 to 150 minutes.

The above positive electrode composition layer contains the conductive auxiliary agent. As the above conductive auxiliary agent, the same conductive auxiliary agent included in the resin current collector described above can be suitably used.

The weight proportion of the conductive auxiliary agent contained in the positive electrode composition layer is preferably 0.1 to 10% by weight based on the weight of the positive electrode composition layer, from the viewpoint of electrical characteristics.

The above conductive auxiliary agent may be included in the coating layer covering the positive electrode active material particles, or may be included in other than the above coating layer.

The thickness of the above positive electrode composition layer is not particularly limited, but is preferably 100 to 800 μm from the viewpoint of energy density.

In the positive electrode for a lithium-ion battery of the present invention, the above current collector and the above positive electrode composition layer are not adhered to each other. Therefore, even if the volume of the positive electrode composition layer changes due to charging and discharging, the current collector does not follow, and thus self-destruction of the positive electrode composition layer and irreversible peeling of the current collector are unlikely to occur.

In the present invention, the fact that the current collector and the positive electrode composition layer are not adhered to each other refers to that the adhesive strength between the current collector and the positive electrode composition layer is 20N or less. The adhesive strength between the current collector and the positive electrode composition layer can be measured in conjunction with the JIS K6850:1999 adhesive strength test. The measurement conditions are as follows.

Test environment: 25° C. Humidity 50%
Measurement device: Shimadzu AUTOGRAPH AGS-10kNX
Measurement condition: As a test piece, a current collector was used instead of the JIS-standard metal plate. The measurement was carried out with a load of 1 kgf/cm² on the adhesive surface of the current collector and the positive electrode composition layer in order to reproduce the environment inside the battery cell.

[Production Method of Positive Electrode for a Lithium-ion Battery] A production method of a positive electrode for a lithium-ion battery according to the present invention is a production method for a positive electrode for a lithium-ion battery comprising a current collector and a positive electrode composition layer disposed on a surface of the current collector, the method comprising the steps of: preparing a positive electrode composition layer by compression-molding a positive electrode composition containing coated positive electrode active material particles in which at least a part of a surface of each positive electrode active material particle is coated with is coated with a coating layer containing a polymer compound (A), and a conductive auxiliary agent; and relocating the positive electrode composition layer on the current collector, wherein the polymer compound (A) is any one of: a copolymer (A1) having methacrylic acid, lauryl methacrylate and 1,6-hexanediol dimethacrylate as constituent monomers; a copolymer (A2) having isobornyl methacrylate and 1,6-hexanediol dimethacrylate as constituent monomers; or a copolymer (A3) having lauryl methacrylate, 2-ethylhexyl methacrylate and 1,6-hexanediol dimethacrylate as constituent monomers, the weight proportion of 1,6-hexanediol dimethacrylate contained in the constituent monomers of the copolymer is 0.2 to 1% by weight based on the total weight of the constituent monomers of the copolymer, and the weight average molecular weight of the polymer compound (A) is 300,000 or less.

A production method of a positive electrode for a lithium-ion battery according to the present invention has a step of preparing a positive electrode composition layer by compression-molding a positive electrode composition containing coated positive electrode active material particles in which at least a part of a surface of each positive electrode active material particle is coated with is coated with a coating layer containing a polymer compound (A), and a conductive auxiliary agent.

Compression molding can be carried out using an arbitrary pressurizing device and pressurizing jig such as a hydraulic press device. For example, a positive electrode composition is put in a cylindrical bottomed container, a round bar-shaped pressurized jig having slightly smaller diameter than the inner diameter of the above bottom container is inserted from thereabove and then compressed by a pressurizing device, whereby the positive electrode composition layer that is a molded body molded into a cylindrical shape can be obtained.

A molded body of arbitrary shape can be obtained by changing the shape of the pressurized jig.

As a compression condition in compression molding, the pressure applied on the positive electrode composition is preferably 100 to 3000 MPa. The pressurization time is preferably 1 to 300 seconds.

The step of compression molding described above may be carried out on the current collector or on a mold release material other than the current collector. The release material is not particularly limited, and a known release paper or a release film can be selected and used as appropriate.

Examples of release material include release paper such as glassin paper, kraft paper, clay coat paper, etc., and a release film made of non-fluororesin such as polyethylene terephthalate (PET), polyethylene (PE), polypropylene, polyimide (PI), etc., or made of fluororesin such as polytetrafluoroethylene (PTFE), ethylene-tetrafluoroethylene copolymer (ETFE), ethylene-hexafluoropropylene copolymer, perfluoroalkoxyalkane (PFA), polyvinylidene fluoride (PVdF), etc.

A production method of a positive electrode for a lithium-ion battery according to the present invention has a step of relocating the positive electrode composition layer obtained in the step of compression molding described above on the current collector.

A method of relocating the positive electrode composition layer on the current collector is not particularly limited, and a known transferring method can be used. A positive electrode for a lithium-ion battery can be obtained by, for example, laminating the positive electrode composition layer, which is formed on the release material in the step of compression molding, on the current collector and peeling off the release material.

### EXAMPLES

The present invention will be specifically described with reference to Examples; however, the present invention is not limited to Examples without departing from the gist of the present invention. Unless otherwise specified, parts mean parts by weight and % means % by weight.

### Production Example 1-1: Production of Polymer Compound (A-1)

66.46 parts of DMF was placed in a four-necked flask equipped with a stirrer, a thermometer, a reflux condenser, a dropping funnel, and a nitrogen gas introduction tube, and the temperature was raised to 75° C. Next, a monomer blending solution obtained by blending 4.6 parts of methacrylic acid, 95.0 parts of lauryl methacrylate, 0.4 parts of 1,6-hexanediol dimethacrylate, and 116.5 parts of DMF, and an initiator solution obtained by dissolving 1.7 parts of 2,2′-azobis(2,4-dimethylvaleronitrile) in 29.15 parts of DMF were continuously added dropwise to the four-necked flask over 2 hours under stirring by using a dropping funnel, while blowing nitrogen thereinto, to carry out radical polymerization. After completion of the dropwise addition, the reaction was continued for 3 hours at 75° C. Next, the temperature was raised to 80° C., and again the initiator solution obtained by dissolving 1.7 parts of 2,2′-azobis(2,4-dimethylvaleronitrile) in 29.15 parts of DMF was continuously added dropwise through the dropping funnel over 2 hours under stirring. After the dropwise addition, the reaction was continued for 3 hours to obtain a copolymer compound for coating layer (A-1) having a resin concentration of 30% was obtained.

### Production Example 1-2: Production of Polymer Compound (A-2)

66.46 parts of DMF was placed in a four-necked flask equipped with a stirrer, a thermometer, a reflux condenser, a dropping funnel, and a nitrogen gas introduction tube, and the temperature was raised to 75° C. Next, a monomer blending solution obtained by blending 99.55 parts of isobornylmethacrylate, 0.45 parts of 1,6-hexanediol dimethacrylate, and 116.5 parts of DMF, and an initiator solution obtained by dissolving 1.7 parts of 2,2′-azobis(2,4-dimethylvaleronitrile) in 29.15 parts of DMF were continuously added dropwise to the four-necked flask over 2 hours under stirring by using a dropping funnel, while blowing nitrogen thereinto, to carry out radical polymerization. After completion of the dropwise addition, the reaction was continued for 3 hours at 75° C. Next, the temperature was raised to 80° C., and again the initiator solution obtained by dissolving 1.7 parts of 2,2′-azobis(2,4-dimethylvaleronitrile) in 29.15 parts of DMF was continuously added dropwise through the dropping funnel over 2 hours under stirring. After the dropwise addition, the reaction was continued for 3 hours to obtain a coating copolymer compound (A-2) having a resin concentration of 30% was obtained.

### Production Example 1-3: Production of Polymer Compound (A-3)

66.46 parts of DMF was placed in a four-necked flask equipped with a stirrer, a thermometer, a reflux condenser, a dropping funnel, and a nitrogen gas introduction tube, and the temperature was raised to 75° C. Next, a monomer blending solution obtained by blending 29.5 parts of lauryl methacrylate, 70.0 parts of 2-ethylhexyl methacrylate, 0.5 part of 1,6-Hexanediol dimethacrylate, and 116.5 parts of DMF, and an initiator solution obtained by dissolving 1.7 parts of 2,2′-azobis(2,4-dimethylvaleronitrile) in 29.15 parts of DMF were continuously added dropwise to the four-necked flask over 2 hours under stirring by using a dropping funnel, while blowing nitrogen thereinto, to carry out radical polymerization. After completion of the dropwise addition, the reaction was continued for 3 hours at 75° C. Next, the temperature was raised to 80° C., and again the initiator solution obtained by dissolving 1.7 parts of 2,2′-azobis(2,4-dimethylvaleronitrile) in 29.15 parts of DMF was continuously added dropwise through the dropping funnel over 2 hours under stirring. After the dropwise addition, the reaction was continued for 3 hours to obtain a coating copolymer compound (A-3) having a resin concentration of 30% was obtained.

### Production Example 1-4: Production of Polymer Compound (A′-1)

66.46 parts of DMF was placed in a four-necked flask equipped with a stirrer, a thermometer, a reflux condenser, a dropping funnel, and a nitrogen gas introduction tube, and the temperature was raised to 75° C. Next, a monomer blending solution obtained by blending 69.5 parts of 2-ethylhexyl methacrylate, 30.0 parts of Ω-methacryloyl-polymethylmethacrylate, 0.5 part of 1,6-hexanediol dimethacrylate, and 116.5 parts of DMF, and an initiator solution obtained by dissolving 1.7 parts of 2,2′-azobis(2,4-dimethylvaleronitrile) in 29.15 parts of DMF were continuously added dropwise to the four-necked flask over 2 hours under stirring by using a dropping funnel, while blowing nitrogen thereinto, to carry out radical polymerization. After completion of the dropwise addition, the reaction was continued for 3 hours at 75° C. Next, the temperature was raised to 80° C., and again the initiator solution obtained by dissolving 1.7 parts of 2,2′-azobis(2,4-dimethylvaleronitrile) in 29.15 parts of DMF was continuously added dropwise through the dropping funnel over 2 hours under stirring. After the dropwise addition, the reaction was continued for 3 hours to obtain a coating copolymer compound (A′-1) having a resin concentration of 30% was obtained.

### Production Example 1-5: Production of Polymer Compound (A′-2)

66.46 parts of DMF was placed in a four-necked flask equipped with a stirrer, a thermometer, a reflux condenser, a dropping funnel, and a nitrogen gas introduction tube, and the temperature was raised to 75° C. Next, a monomer blending solution obtained by blending 20.0 parts of isobornyl methacrylate, 49.5 parts of 2-ethylhexyl acrylate, 30.0 parts butyl methacrylate, 0.5 parts of 1,6-hexanediol dimethacrylate, and 116.5 parts of DMF, and an initiator solution obtained by dissolving 1.7 parts of 2,2′-azobis(2,4-dimethylvaleronitrile) in 29.15 parts of DMF were continuously added dropwise to the four-necked flask over 2 hours under stirring by using a dropping funnel, while blowing nitrogen thereinto, to carry out radical polymerization. After completion of the dropwise addition, the reaction was continued for 3 hours at 75° C. Next, the temperature was raised to 80° C., and again the initiator solution obtained by dissolving 1.7 parts of 2,2′-azobis(2,4-dimethylvaleronitrile) in 29.15 parts of DMF was continuously added dropwise through the dropping funnel over 2 hours under stirring. After the dropwise addition, the reaction was continued for 3 hours to obtain a coating copolymer compound (A′-2) having a resin concentration of 30% was obtained.

### Production Example 1-6: Production of Polymer Compound (A′-3)

66.46 parts of DMF was placed in a four-necked flask equipped with a stirrer, a thermometer, a reflux condenser, a dropping funnel, and a nitrogen gas introduction tube, and the temperature was raised to 75° C. Next, a monomer blending solution obtained by blending 4.75 parts of methacrylic acid, 95.15 parts of lauryl methacrylate, 0.10 part of 1,6-hexanediol dimethacrylate, and 116.5 parts of DMF, and an initiator solution obtained by dissolving 1.7 parts of 2,2′-azobis(2,4-dimethylvaleronitrile) in 29.15 parts of DMF were continuously added dropwise to the four-necked flask over 2 hours under stirring by using a dropping funnel, while blowing nitrogen thereinto, to carry out radical polymerization. After completion of the dropwise addition, the reaction was continued for 3 hours at 75° C. Next, the temperature was raised to 80° C., and again the initiator solution obtained by dissolving 1.7 parts of 2,2′-azobis(2,4-dimethylvaleronitrile) in 29.15 parts of DMF was continuously added dropwise through the dropping funnel over 2 hours under stirring. After the dropwise addition, the reaction was continued for 3 hours to obtain a coating copolymer compound (A′-3) having a resin concentration of 30% was obtained.

TABLE 1-1

| Polymer compound | | (A-1) | (A-2) | (A-3) | (A′-1) | (A′-2) | (A′-3) |
|---|---|---|---|---|---|---|---|
| Constituent | Methacrylic acid | 4.6 | — | — | — | — | 4.75 |
| monomer | Lauryl methacrylate | 95 | — | 29.5 | — | — | 95.15 |
| | Isobornyl methacrylate | — | 99.55 | — | — | 20 | — |
| | 2-ethylhexyl | — | — | 70 | 69.5 | — | — |
| | methacrylate | | | | | | |
| | Ω-methacryloyl- | — | — | — | 30 | — | — |
| | polymethylmethacrylate | | | | | | |
| | 2-ethylhexyl acrylate | — | — | — | — | 49.5 | — |
| | Butyl methacrylate | — | — | — | — | 30 | — |
| | 1,6-hexanediol | 0.4 | 0.45 | 0.5 | 0.5 | 0.5 | 0.1 |
| | dimethacrylate | | | | | | |
| Physical | Tg[° C.] | −56 | 120 | −44 | 8.8 | 10 | −75 |
| property | Mw | 89000 | 60650 | 83000 | 85000 | 132000 | 70000 |

### Production Example 1-7: Production of Coated Positive Electrode Active Material Particles (CA-1)

96 parts of positive electrode active material powder (C-1) (LiNi_{0.8}Co_{0.15}Al_{0.05}O₂ powder, volume average particle size: 4 μm) was placed in an all-purpose mixer, High Speed Mixer FS25 [manufactured by EARTHTECHNICA Co., Ltd.], and at room temperature and in a state of the powder being stirred at 720 rpm, 6.667 parts of a polymer compound solution for coating layer (A-1) obtained in Production Example 1-1 was added dropwise over 2 minutes, and then the resultant mixture was further stirred for 5 minutes.

Next, in a state of the resultant mixture being stirred, 2.0 parts of acetylene black [DENKA BLACK (registered trade name) manufactured by Denka Company Limited] was divisionally added as a conductive auxiliary agent in 26 minutes, and stirring was continued for 30 minutes. Then, the pressure was reduced to 0.01 MPa while maintaining the stirring, the temperature was subsequently raised to 140° C. while maintaining the stirring and the degree of pressure reduction, and the stirring, the degree of pressure reduction, and the temperature were maintained for 8 hours to distill off the volatile matter. The obtained powder was classified with a sieve having a mesh size of 212 μm to obtain coated positive electrode active material particles (CA-1).

Coated positive electrode active material particles (CA-2) to (CA-3) and (CA′-1) to (CA′-3) were obtained in the same procedure as Production Example 1-7 except that the polymer compound solution for coating layer (A-1) was changed to (A-2) to (A-3) and (A′-1) to (A′-3), respectively. The details of combination are as shown in Table 1-2.

### Production Example 1-8: Production of Coated Positive Electrode Active Material Particles (CA-4)

91.5 parts of a positive electrode active material powder (C-1) (LiNi_{0.8}Co_{0.15}Al_{0.05}O₂ powder, volume average particle size: 4 μm) was placed in an all-purpose mixer, High Speed Mixer FS25 [manufactured by EARTHTECHNICA Co., Ltd.], and at room temperature and in a state of the powder being stirred at 720 rpm, 7.0 parts of a polymer compound solution for coating layer (A-1) obtained in Production Example 1-1 was added dropwise over 2 minutes, and then the resultant mixture was further stirred for 5 minutes.

Next, in a state of the resultant mixture being stirred, 6.4 parts of acetylene black [DENKA BLACK (registered trade name) manufactured by Denka Company Limited] was divisionally added as a conductive auxiliary agent in 26 minutes, and stirring was continued for 30 minutes. Then, the pressure was reduced to 0.01 MPa while maintaining the stirring, the temperature was subsequently raised to 140° C. while maintaining the stirring and the degree of pressure reduction, and the stirring, the degree of pressure reduction, and the temperature were maintained for 8 hours to distill off the volatile matter. The obtained powder was classified with a sieve having a mesh size of 212 μm to obtain coated positive electrode active material particles (CA-4).

Coated positive electrode active material particles (CA-5) to (CA-6) and (CA′-4) to (CA′-6) were obtained in the same procedure as Production Example 1-8 except that the polymer compound solution for coating layer (A-1) was changed to (A-2) to (A-3) and (A′-1) to (A′-3), respectively. The details of combination are as shown in Table 1-2.

### Production Example 1-9: Production of Electrolyte Solution

LiPF₆ was dissolved at a proportion of 1 mol/L in a mixed solvent of ethylene carbonate and propylene carbonate (volume ratio 1:1) to obtain an electrolyte solution for a lithium-ion battery.

### Production Example 1-10: Production of a Current Collector

In a twin-screw extruder, 10 parts of trade name “SunAllomer PB522M” [available from SunAllomer Ltd.], 25 parts of trade name “SunAllomer PM854X” [available from SunAllomer Ltd.], 10 parts of trade name “Suntec B680” [available from Asahi Kasei Chemicals Corporation], 40 parts of graphite particles “SNG-WXA1”, 10 parts of acetylene black 1 “Ensaco 250G” and 5 parts of trade name “Umex 1001 (acid-modified polypropylene)” [available from Sanyo Chemical Industries, Ltd.] were melt-kneaded at 100 rpm at 180° C. with a residence time of 5 minutes to obtain a material for a resin current collector.

The obtained material for a resin current collector was passed through a T-die film extruder, and then rolled by a heat press machine of which the temperature was controlled to 50° C. to obtain a resin current collector.

### Example 1-1

5 g of coated positive electrode active material particles (CA-1) obtained in Production Example 1-7, 0.026 g of a carbon fiber as a conductive auxiliary agent [Donna Carbo Milled S-242, available from Osaka Gas Chemicals Co., Ltd.] and 0.2632 g of flaky graphite [UP-5-a, available from Nippon Graphite Co., Ltd.] were mixed using a planetary stirring type mixing and kneading device {Awatori Rentaro [THINKY Corporation]} at 1,500 rpm for 3 minutes.

Further, after adding 0.14 g of the electrolytic solution prepared in Production Example 1-9, mixing was carried out twice at 1,500 rpm for 1 minute with Awatori Rentaro and 0.28 g in total of the electrolyte solution was added to obtain a positive electrode composition.

0.217 g of the above-described positive electrode composition was weighed and placed in a cylindrical bottomed container with an inner diameter of 15 mm, and then compressed with a pressurizing device, whereby a positive electrode composition layer (CE-1) formed into a cylindrical shape was obtained.

The pressurizing conditions were a pressurizing pressure of 150 MPa and a pressurizing time of 5 seconds, and the temperature of the pressurizing device (pressurizing jig) was 20° C., which was equal to the room temperature at the time of pressurizing.

### Examples 1-2 to 1-6, Comparative Examples 1-1 to 1-6

Positive electrode composition layers (CE-2) to (CE-6) and (CE′-1) to (CE′-6) were prepared in the same way as Example 1-1 except that the coated positive electrode active material particles (CA-1) were changed to the coated positive electrode active material particles (CA-2) to (CA-6) and (CA′-1) to (CA′-6). The detailed combinations are as shown in Table 1-2.

<Evaluation of Internal Resistance of Cell>

A PP sheet (available from AS ONE corporation) cut into 2 cm squares was prepared, and a hole of φ18 mm was provided in the center. The prepared positive electrode composition layer (CE-1) and the Li foil cut out to φ15 mm were stored in the hole of φ18 mm provided in the center of the PP sheet with the layer and the foil placed at the poles across a separator made of PP (available from Celgard, LLC), the electrolyte solution was poured to be 110% with respect to the gap of the positive electrode composition layer (CE-1) and the separator, and the resin current collector obtained in Production Example 1-10 and a copper foil cut into 2 cm squares were placed on the outside of each of the positive electrode composition layer (CE-1) and the Li foil. This was heat-sealed under reduced pressure to prepare an evaluation cell.

At this time, a 2 cm square A1 foil with a lead was applied to the resin current collector, a 2 cm square Cu foil with a lead was applied to the copper foil, and they were heat sealed under reduced pressure with an aluminum laminate pack while only the lead was exposed. Each lead was connected to a charging and discharging device “HJ0501SM8A” [available from HOKUTO DENKO Corporation], and DCR was evaluated under the following conditions.

The charging was carried out with CC-CV (cutoff current 0.01 C) up to 4.2V at 1 C, and after paused for 1 hour, the discharging was carried out up to 2.5V at 0.1 C. The internal resistance of each cell was evaluated where the voltage immediately before the discharge was VO, the voltage after discharge was V1, the current during the discharge was the Il, and (V-V0)/I1 was a DC resist (DCR). The evaluation was carried out on the following criteria. The results are described in Table 1-2.

⊚: DCR is less than 15 Ω/cm2
◯: DCR is 15 Ω·cm2 or more, less than 21 Ω·cm2
Δ: DCR is 21 Ω·cm2 or more, less than 26 Ω·cm2
X: DCR is 26 Ω·CM2 or more

<Evaluation of Cycle Characteristics>

Similar to the DCR evaluation, the evaluation cell was connected to the charging and discharging device, and the cycle characteristics were evaluated under the following conditions.

The charging was carried out with CC-CV (cutoff current 0.01 C) up to 4.2V at 1 C, and after paused for 1 hour, the discharging was carried out up to 2.5V at 0.1 C. The discharge capacity at this time was set to an initial capacity of X₀. This was repeated 50 times to obtain the discharge capacity X₁ of the 50th cycle. The cycle characteristics were evaluated for the cycle characteristics using X₁/X₀ as a 50-cycle discharge capacity retention rate. The evaluation was carried out on the following criteria. The results are described in Table 1-2.

⊚: The discharge capacity retention rate is 97% or more
∘: The discharge capacity retention rate is 93% or more, less than 97%
Δ: The discharge capacity retention rate is 89% or more, less than 93%
x: The discharge capacity retention rate is less than 89%

TABLE 1-2

| | | | Coated | | | | |
|---|---|---|---|---|---|---|---|
| | | Positive | positive | | | Discharge | |
| | | electrode | electrode | | | capacity | |
| | | active | active | | Internal | retention | Evaluation |
| | Polymer | material | material | DCR | resistance | rate | of cycle |
| | compound | particles | particles | [Ω · cm²] | of cell | [%@50 cyc] | characteristics |
| Examples 1-1 | A-1 | C-1 | CA-1 | 14 | ⊚ | 97 | ⊚ |
| Examples 1-2 | A-2 | C-1 | CA-2 | 18 | ◯ | 96 | ◯ |
| Examples 1-3 | A-3 | C-1 | CA-3 | 20 | ◯ | 95 | ◯ |
| Examples 1-4 | A-1 | C-2 | CA-4 | 16 | ◯ | 97 | ⊚ |
| Examples 1-5 | A-2 | C-2 | CA-5 | 19 | ◯ | 95 | ◯ |
| Examples 1-6 | A-3 | C-2 | CA-6 | 20 | ◯ | 96 | ◯ |
| Comparative | A′-1 | C-1 | CA′-1 | 26 | X | 90 | Δ |
| Example 1-1 | | | | | | | |
| Comparative | A′-2 | C-1 | CA′-2 | 24 | Δ | 87 | X |
| Example 1-2 | | | | | | | |
| Comparative | A′-3 | C-1 | CA′-3 | 23 | Δ | 83 | X |
| Example 1-3 | | | | | | | |
| Comparative | A′-1 | C-2 | CA′-4 | 28 | X | 89 | Δ |
| Example 1-4 | | | | | | | |
| Comparative | A′-2 | C-2 | CA′-5 | 27 | X | 88 | X |
| Example 1-5 | | | | | | | |
| Comparative | A′-3 | C-2 | CA′-6 | 25 | Δ | 83 | X |
| Example 1-6 | | | | | | | |

The results in Tables 1-2 show that lithium-ion batteries produced using the positive electrode for a lithium-ion battery have low internal resistance and excellent cycle characteristics.

### [Negative Electrode for a Lithium-Ion Battery and Production Method for Negative Electrode for a Lithium-Ion Battery]

Subsequently, a negative electrode for a lithium-ion battery and a production method for a negative electrode for a lithium-ion battery will be described.

The methods disclosed in PTLs 1 and 2 were not sufficiently effective for large-area electrodes, where the effect of volume change of the electrode active material layer is significant. There has also been room for further improvement in terms of energy density and cycle characteristics.

The negative electrode for a lithium-ion battery described below was developed to solve the above-mentioned problems; the negative electrode for a lithium-ion battery concerned has excellent energy density and cycle characteristics, and the surface area thereof can be increased.

A negative electrode for a lithium-ion battery has a current collector and a negative electrode composition layer disposed on a surface of the current collector, wherein the current collector and the negative electrode composition layer are not adhered to each other; the negative electrode composition layer contains coated negative electrode active material particles in which at least a part of a surface of each negative electrode active material particle is coated with a coating layer containing a polymer compound (B), and a conductive auxiliary agent; the polymer compound (B) is a copolymer containing at least one monomer selected from the group consisting of acrylic acid and 2-ethylhexyl methacrylate as an essential constituent monomer; and the total weight ratio of the acrylic acid and the 2-ethylhexyl methacrylate is 60% by weight or more based on the total weight of the constituent monomers of the copolymer.

The negative electrode for a lithium-ion battery has a current collector. Examples of material constituting the current collector include metal materials such as copper, aluminum, titanium, stainless steel, nickel and alloys thereof, calcined carbon, conductive polymer material, conductive glass and the like.

Of these materials, a conductive polymer material is preferable from the viewpoint of weight reduction, corrosion resistance, and high conductivity.

The shape of the current collector is not particularly limited, and may be a sheet-shaped current collector made of the above materials. Further, the current collector may be a deposited layer made of fine particles composed of the above materials.

The thickness of the current collector is not particularly limited, but is preferably 50 to 500 μm.

The current collector is preferably a resin current collector made of a conductive polymer material.

As the conductive polymer material constituting the resin current collector, for example, a conductive polymer or a resin to which a conductive agent is added, if necessary, can be used.

Examples of the conductive agent constituting the conductive polymer material include metal-based conductive auxiliary agents [aluminum, stainless steel (SUS), silver, gold, copper, titanium and alloys containing these metals], carbon-based conductive agents [graphite and carbon black (acetylene black, Ketjen black, furnace black, channel black, thermal lamp black, etc.), etc.], and mixtures thereof, etc.

One kind of these conductive auxiliary agents may be used alone, or two or more kinds thereof may be used in combination. From the viewpoint of electrical stability, aluminum, stainless steel, silver, gold, copper, titanium, a carbon-based conductive auxiliary agent, or a mixture thereof is preferable, silver, gold, aluminum, stainless steel, or a carbon-based conductive auxiliary agent is more preferable, and a carbon-based conductive auxiliary agent is particularly preferable. Further, these conductive auxiliary agents may be those obtained by coating a conductive material [preferably, a metallic conductive material among materials of the conductive auxiliary agent described above] around a particle-based ceramic material or a resin material with plating or the like.

The average particle size of the conductive auxiliary agent is not particularly limited; however, it is preferably 0.01 to 10 μm, more preferably 0.02 to 5 μm, and still more preferably 0.03 to 1 μm, from the viewpoint of the electrical characteristics of the battery. The “particle size” means the maximum distance L among the distances between any two points on the contour line of the conductive auxiliary agent. As the value of the “average particle size”, the average value of the particle sizes of the particles observed in several to several tens of visual fields using an observation means such as a scanning electron microscope (SEM) or a transmission electron microscope (TEM) shall be adopted.

The shape (the form) of the conductive auxiliary agent is not limited to the particle form, may be a form other than the particle form, and may be a form practically applied as a so-called filler-based conductive auxiliary agent such as carbon nanotubes.

The conductive auxiliary agent may be a conductive fiber of which the shape is fibrous.

Examples of the conductive fiber include a carbon fiber such as a PAN-based carbon fibers or a pitch-based carbon fiber, a conductive fiber obtained by uniformly dispersing a metal having good conductivity or graphite in the synthetic fiber, a metal fiber obtained by making a metal such as stainless steel into a fiber, a conductive fiber obtained by coating a surface of an organic fiber with a metal, and a conductive fiber obtained by coating a surface of an organic fiber with a resin containing a conductive substance. Among these conductive fibers, a carbon fiber is preferable. In addition, a polypropylene resin in which graphene is kneaded is also preferable.

In a case where the conductive auxiliary agent is a conductive fiber, the average fiber diameter thereof is preferably 0.1 to 20

The content of a conductive auxiliary agent is preferably 1 to 79 wt %, more preferably 2 to 30 wt %, and still preferably 5 to 25 wt %, from the viewpoint of dispersibility of the conductive auxiliary agent.

Examples of resins constituting the conductive polymer material include polyethylene, polypropylene, polymethylpentene, polycycloolefin, polyethylene terephthalate, polyether nitrile, polytetrafluoroethylene, styrene butadiene rubber, polyacrylonitrile, polymethyl acrylate, polymethyl methacrylate. polyfluoride vinylidene, epoxy resin, silicone resin or a mixture thereof and the like.

From the viewpoint of electrical stability, polyethylene, polypropylene, polymethylpentene and polycycloolefin are preferable, and polyethylene, polypropylene and polymethylpentene are more preferable.

The content of resin constituting the conductive polymer material is preferably 20 to 98% by weight, more preferably 40 to 95% by weight, and still preferably 60 to 92% by weight, based on the weight of the resin current collector from the viewpoint of resin strength.

The resin current collector described above can be produced, for example, by the following method.

First, a material for a resin current collector is obtained by mixing a resin, a conductive auxiliary agent and, if necessary, other components.

Examples of the mixing method include a method of obtaining a master batch of conductive filler and then further mixing with a resin, a method of using a master batch of a resin, a conductive auxiliary agent and, if necessary, other components, and a method of mixing all raw materials collectively, and for the mixing, a suitable known mixer for mixing pellet-like or powder-like components, for example, a kneader, an internal mixer, a Banbury mixer and a roll can be used.

There is no particular limitation on the order of addition of each component during mixing. The obtained mixture may be further pelletized by a pelletizer, or powdered.

Forming the obtained material for the current collector into, for example, a film, whereby the above resin current collector can be obtained. Examples of the method for forming into a shape of a film include the T-die method, inflation method, calendering method, and other known film forming methods. The above resin current collector can also be obtained by molding methods other than film molding.

The negative electrode for a lithium-ion battery has a negative electrode composition layer.

The negative electrode composition layer is not adhered to the current collector.

The above negative electrode composition layer contains coated negative electrode active material particles in which at least a part of a surface of each negative electrode active material particle is coated with a coating layer containing a polymer compound (B), and a conductive auxiliary agent.

The above negative electrode active material particles are not particularly limited as long as they can be used as the negative electrode active material of the lithium-ion battery. Examples of the material constituting the negative electrode active material include carbon-based materials and silicon-based materials, for example. Among them, the negative electrode active material is preferably made of a carbon-based material.

Examples of the carbon-based material include, for example, graphite, non-graphitizable carbon, amorphous carbon, a resin sintered product (for example, a sintered product obtained by sintering and carbonizing a phenol resin, a furan resin, or the like), cokes (for example, a pitch coke, a needle coke, and a petroleum coke), or the like. A mixture of a conductive macromolecule (for example, polyacetylene or polypyrrole), a metal oxide (a titanium oxide, a lithium-titanium oxide, or the like), a metal alloy (for example, a lithium-tin alloy, a lithium-aluminum alloy, or an aluminum-manganese alloy), or the like, and a carbon-based material may be used. Regarding the material that does not contain lithium or lithium ions in the inside thereof, a part or all of the inside may be subjected to pre-doping treatment to incorporate lithium or lithium ions.

A silicon-based material is preferably at least one selected from the group consisting of silicon oxide (SiOx), a Si—C composite body, a Si—Al alloy, a Si—Li alloy, a Si—Ni alloy, a Si—Fe alloy, a Si—Ti alloy, a Si—Mn alloy, a Si—Cu alloy and a Si—Sn alloy. Examples of the Si—C composite body include silicon carbide, carbon particles whose surfaces are coated with silicon and/or silicon carbide, and silicon particles and silicon oxide particles each of whose surfaces is coated with carbon and/or silicon carbide.

The silicon and/or silicon compound particles may be single particles (also referred to as primary particles) or may form composite particles obtained by aggregating the primary particles (that is, secondary particles obtained by aggregating the primary particles composed of silicon and/or the silicon compound). Two types of composite particles exist, i.e., the case where the primary particles of silicon and/or silicon compound particles are aggregated by the adsorption force thereof, and the case where the primary particles are aggregated by being adsorbed via another material. Examples of a method of forming composite particles by binding the primary particle via another material include, for example, a method of mixing the primary particles of silicon and/or the silicon compound particle and the polymer compound constituting the coating film.

An average particle size of the negative electrode active material particles is preferably 0.1 to 100 μm, more preferably 1 to 50 μm, and further preferably 2 to 20 μm, from the viewpoint of battery characteristics.

The volume average particle size of the negative electrode active material particles means the particle size (Dv50) at an integrated value of 50% in the particle size distribution obtained by the microtrack method (the laser diffraction/scattering method). The microtrack method is a method of determining a particle size distribution by using scattered light obtained by irradiating particles with laser light. A laser diffraction/scattering type particle size distribution measurement device [MICROTRAC available from MicrotracBEL Corp.] can be used for measuring the volume average particle size.

The above polymer compound (B) is a copolymer containing at least one monomer selected from the group consisting of acrylic acid and 2-ethylhexyl methacrylate as an essential constituent monomer, and the total weight proportion of acrylic acid and 2-ethylhexyl methacrylate is 60% by weight or more based on the total weight of the constituent monomers of the above copolymer.

When the total weight proportion of acrylic acid and 2-ethylhexyl methacrylate in the copolymer is less than 60% by weight based on the total weight of the constituent monomers of the above copolymer, the cycle characteristics deteriorate.

The weight proportion of acrylic acid and 2-ethylhexyl methacrylate contained in the constituent monomers of the above copolymer can be measured by a method such that a copolymer is dissolved in a supercritical fluid and the obtained oligomer component is analyzed by a gas chromatography mass analysis (GC-MS) method.

The polymer compound (B) may contain a constituent monomer other than acrylic acid and 2-ethylhexyl methacrylate.

Examples of the constituent monomers other than acrylic acid and 2-ethylhexyl methacrylate include 2-methylhexyl acrylate, methyl methacrylate and the like.

Further, it is preferable that the polymer compound (B) does not contain 1,6-hexanediol dimethacrylate as a constituent monomer.

A weight average molecular weight [hereinafter, abbreviated as Mw: the measurement is based on the gel permeation chromatography (GPC) method described later] of the above polymer compound (B) is preferably 300,000 or less. If Mw of the above polymer compound (B) exceeds 300,000, the viscosity of the resin solution may increase too much and a good coating may not be obtained.

Mw of the polymer compound (B) is more preferably 200,000 or less, and further preferably 150,000 or less. Mw of the polymer compound (B) is preferably 40,000 or more, and more preferably 70,000 or more.

The measurement conditions of Mw by GPC are as follows.

Device: high temperature gel permeation chromatograph [“Alliance GPC V2000”, available from Waters Corporation] Solvent: ortho-dichlorobenzene
Standard substance: polystyrene
Sample concentration: 3 mg/ml
Column solid phase: PLgel 10 MIXED-B, two columns connected in series (Polymer Laboratories Limited)
Column temperature: 135° C.

The above polymer compound (B) can be produced by a known polymerization method (mass polymerization, solution polymerization, emulsification polymerization, suspension polymerization, etc.) using known polymerization initiators {azo-based initiators [2,2′-azobis(2-methylpropionitrile), 2,2′-azobis(2,4-dimethylvaleronitrile, etc.)], peroxide-based initiators (benzoyl peroxide, di-t-butyl peroxide, lauryl peroxide, etc.)}.

The amount of the polymerization initiator used is preferably 0.01 to 5% by weight, more preferably 0.05 to 2% by weight, further preferably 0.1 to 1.5% by weight based on the total weight of the monomers, from the viewpoint of adjusting Mw to a preferable range, and while the polymerization temperature and polymerization time are adjusted depending on the type of polymerization initiator and the like, the polymerization temperature is preferably −5 to 150° C. (more preferably 30 to 120° C.), and the reaction time is preferably 0.1 to 50 hours (more preferably 2 to 24 hours).

Examples of the solvent used in the case of solution polymerization include esters (C2-C8, such as ethyl acetate and butyl acetate), alcohols (C1-C8, such as methanol, ethanol and octanol), and hydrocarbons (C4-C8, such as n-butane, cyclohexane and toluene) and ketones (C3-C9, such as methyl ethyl ketone). From the viewpoint of adjusting the molecular weight to a preferable range, the amount used is preferably 5 to 900% by weight, more preferably 10 to 400% by weight, and particularly preferably 30 to 300% by weight based on the total weight of the monomers, and the monomer concentration is preferably 10 to 95% by weight, more preferably 20 to 90% by weight, and particularly preferably 30 to 80% by weight.

Examples of the dispersion medium in emulsification polymerization and suspension polymerization include water, alcohol (such as ethanol), ester (such as ethyl propionate), light naphtha, etc., and examples of the emulsifier include higher fatty acid (C10-C24) metal salt (such as sodium oleate and sodium stearate), higher alcohol (C10-C24) sulfate ester metal salt (such as sodium lauryl sulfate), ethoxylated tetramethyldecinediol, sodium sulfoethyl methacrylate, dimethylaminomethyl methacrylate, etc. Further, polyvinyl alcohol, polyvinyl pyrrolidone, etc. may be added as stabilizers.

The monomer concentration of the solution in solution polymerization and the monomer concentration of the dispersion in emulsion polymerization and suspension polymerization are preferably 5 to 95% by weight, more preferably 10 to 90% by weight, still more preferably 15 to 85% by weight. The amount of the polymerization initiator used is preferably 0.01 to 5% by weight, more preferably 0.05 to 2% by weight, based on the total weight of the monomer.

For polymerization, known chain transfer agents such as mercapto compounds (dodecyl mercaptan, n-butyl mercaptan, etc.) and/or halogenated hydrocarbons (carbon tetrachloride, carbon tetrabromide, benzyl chloride, etc.) can be used.

In the coated negative electrode active material particles, at least a part of a surface of each negative electrode active material particle is coated with a coating layer containing a polymer compound (B). The coating layer may further contain a conductive material, if necessary.

The weight proportion of the above polymer compound (B) to the weight of the above negative electrode active material particles is not particularly limited, but is preferably 0.1 to 10% by weight from the viewpoint of fixing the positions of the coated negative electrode active material particles, and from the viewpoint of moldability of the negative electrode composition layer.

For example, the above coated negative electrode active material particles can be obtained as follows: while the above negative electrode active material particles are stirred at 30 to 50 rpm in a universal mixer, a resin solution containing the above polymer compound (A) is added dropwise thereto over 1 to 90 minutes; the conductive auxiliary agent is further added if necessary; while the mixture is stirred, the temperature is raised to 50 to 200° C., and the pressure is reduced to 0.007 to 0.04 MPa; and the mixture is then kept in this state for 10 to 150 minutes.

The above negative electrode composition layer contains the conductive auxiliary agent. As the above conductive auxiliary agent, the same conductive auxiliary agent included in the resin current collector described above can be suitably used.

The weight proportion of the conductive auxiliary agent contained in the negative electrode composition layer is preferably 0.1 to 10% by weight based on the weight of the negative electrode composition layer, from the viewpoint of electrical characteristics.

The above conductive auxiliary agent may be included in the coating layer covering the negative electrode active material particles, or may be included in other than the above coating layer.

The thickness of the above negative electrode composition layer is not particularly limited, but is preferably 110 to 900 μm from the viewpoint of energy density.

In the negative electrode for a lithium-ion battery, the above current collector and the above negative electrode composition layer are not adhered to each other. Therefore, even if the volume of the negative electrode composition layer changes due to charging and discharging, the current collector does not follow, and thus self-destruction of the negative electrode composition layer and irreversible peeling of the current collector are unlikely to occur.

The fact that the current collector and the negative electrode composition layer are not adhered to each other refers to that the adhesive strength between the current collector and the negative electrode composition layer is 20N or less. The adhesive strength between the current collector and the negative electrode composition layer can be measured in conjunction with the JIS K6850:1999 adhesive strength test. The measurement conditions are as follows.

Test environment: 25° C. Humidity 50%
Measurement device: Shimadzu AUTOGRAPH AGS-10kNX
Measurement condition: As a test piece, a current collector was used instead of the JIS-standard metal plate. The measurement is carried out with a load of 1 kgf/cm² on the adhesive surface of the current collector and the negative electrode composition layer in order to reproduce the environment inside the battery cell.

[Production Method of Negative Electrode for a Lithium-ion Battery] A production method of a negative electrode for a lithium-ion battery is a production method for a negative electrode for a lithium-ion battery comprising a current collector and a negative electrode composition layer disposed on a surface of the current collector, the method comprising the steps of: preparing a negative electrode composition layer by compression-molding a negative electrode composition containing coated negative electrode active material particles in which at least a part of a surface of each negative electrode active material particle is coated with is coated with a coating layer containing a polymer compound (B), and a conductive auxiliary agent; and relocating the negative electrode composition layer on the current collector, the polymer compound (B) is a copolymer containing at least one monomer selected from the group consisting of acrylic acid and 2-ethylhexyl methacrylate as an essential constituent monomer; and the total weight ratio of the acrylic acid and the 2-ethylhexyl methacrylate is 60% by weight or more based on the total weight of the constituent monomers of the copolymer.

A production method of a negative electrode for a lithium-ion battery has a step of preparing a negative electrode composition layer by compression-molding a negative electrode composition containing coated negative electrode active material particles in which at least a part of a surface of each negative electrode active material particle is coated with is coated with a coating layer containing a polymer compound (B), and a conductive auxiliary agent.

Compression molding can be carried out using an arbitrary pressurizing device and pressurizing jig such as a hydraulic press device. For example, a negative electrode composition is put in a cylindrical bottomed container, a round bar-shaped pressurized jig having slightly smaller diameter than the inner diameter of the above bottom container is inserted from thereabove and then compressed by a pressurizing device, whereby the negative electrode composition layer that is a molded body molded into a cylindrical shape can be obtained.

A molded body of arbitrary shape can be obtained by changing the shape of the pressurized jig.

As a compression condition in compression molding, the pressure applied on the negative electrode composition is preferably 100 to 3000 MPa. The pressurization time is preferably 1 to 300 seconds.

The step of compression molding described above may be carried out on the current collector or on a mold release material other than the current collector. The release material is not particularly limited, and a known release paper or a release film can be selected and used as appropriate.

Examples of release material include release paper such as glassin paper, kraft paper, clay coat paper, etc., and a release film made of non-fluororesin such as polyethylene terephthalate (PET), polyethylene (PE), polypropylene, polyimide (PI), etc., or made of fluororesin such as polytetrafluoroethylene (PTFE), ethylene-tetrafluoroethylene copolymer (ETFE), ethylene-hexafluoropropylene copolymer, perfluoroalkoxyalkane (PFA), polyvinylidene fluoride (PVdF), etc.

A production method of a negative electrode for a lithium-ion battery has a step of relocating the negative electrode composition layer obtained in the step of compression molding described above on the current collector.

A method of relocating the negative electrode composition layer on the current collector is not particularly limited, and a known transferring method can be used. A negative electrode for a lithium-ion battery can be obtained by, for example, laminating the negative electrode composition layer, which is formed on the release material in the step of compression molding, on the current collector and peeling off the release material.

### Examples

Subsequently, a negative electrode for a lithium-ion battery and a production method of a negative electrode for a lithium-ion battery will be specifically described with reference to Examples; however, the negative electrode for a lithium-ion battery and the production method of a negative electrode for a lithium-ion battery described above are not limited to the following Examples without departing from the gist of the negative electrode for a lithium-ion battery and the production method of a negative electrode for a lithium-ion battery described above. Unless otherwise specified, parts mean parts by weight and % means % by weight.

### Production Example 2-1: Production of Polymer Compound (B-1)

66.46 parts of DMF was placed in a four-necked flask equipped with a stirrer, a thermometer, a reflux condenser, a dropping funnel, and a nitrogen gas introduction tube, and the temperature was raised to 75° C. Next, a monomer blending solution obtained by blending 10.0 parts of methacrylic acid, 90.0 parts of 2-ethylhexyl methacrylate and 116.5 parts of DMF, and an initiator solution obtained by dissolving 1.7 parts of 2,2′-azobis(2,4-dimethylvaleronitrile) in 29.15 parts of DMF were continuously added dropwise to the four-necked flask over 2 hours under stirring by using a dropping funnel, while blowing nitrogen thereinto, to carry out radical polymerization. After completion of the dropwise addition, the reaction was continued for 3 hours at 75° C. Next, the temperature was raised to 80° C., and again the initiator solution obtained by dissolving 1.7 parts of 2,2′-azobis(2,4-dimethylvaleronitrile) in 29.15 parts of DMF was continuously added dropwise through the dropping funnel over 2 hours under stirring. After the dropwise addition, the reaction was continued for 3 hours to obtain a copolymer compound for coating layer (B-1) having a resin concentration of 30% was obtained.

### Production Examples 2-2 to 2-8: Production of Polymer Compounds (B-2) to (B-5) and (B′-1) to (B′-3)

Solutions of polymer compounds (B-2) to (B-5) and (B′-1) to (B′-3) were prepared in the same manner as in Production Example 2-1, except that the monomers to be placed were changed according to Table 2-1.

TABLE 2-1

| Polymer compound | | (B-1) | (B-2) | (B-3) | (B-4) | (B-5) | (B′-1) | (B′-2) | (B′-3) |
|---|---|---|---|---|---|---|---|---|---|
| Constituent | Methacrylic acid | 10.0 | 91.0 | 81.0 | 30.0 | 60.0 | 40.0 | 30.0 | 24.0 |
| monomers | 2-ethylhexyl | 90.0 | — | — | 46.0 | — | — | — | — |
| | methacrylate | | | | | | | | |
| | 2-ethylhexyl | — | — | 10.0 | 24.0 | 40.0 | 59.5 | 69.5 | 76.0 |
| | acrylate | | | | | | | | |
| | methyl | — | 9.0 | 9.0 | — | — | — | — | — |
| | methacrylate | | | | | | | | |
| | 1,6-hexanediol | — | — | — | — | — | 0.5 | 0.5 | — |
| | dimethacrylate | | | | | | | | |

| | | | | | | | | |
|---|---|---|---|---|---|---|---|---|
| Mw | 84000 | 86000 | 90000 | 72000 | 75000 | 85000 | 87000 | 75000 |

### Production Example 2-9: Production of Coated Negative Electrode Active Material Particles (DB-1)

87 parts of negative electrode active material powder (D-1) (hard carbon available from JFE Chemical Corporation) was placed in an all-purpose mixer, High Speed Mixer FS25 [manufactured by EARTHTECHNICA Co., Ltd.], and at room temperature and in a state of the powder being stirred at 720 rpm, 20.2 parts of a coating polymer compound solution (B-1) obtained in Production Example 2-1 was added dropwise over 2 minutes, and then the resultant mixture was further stirred for 5 minutes.

Next, in a state of the resultant mixture being stirred, 6.0 parts of acetylene black [DENKA BLACK (registered trade name) manufactured by Denka Company Limited] was divisionally added as a conductive auxiliary agent in 26 minutes, and stirring was continued for 30 minutes. Then, the pressure was reduced to 0.01 MPa while maintaining the stirring, the temperature was subsequently raised to 140° C. while maintaining the stirring and the degree of pressure reduction, and the stirring, the degree of pressure reduction, and the temperature were maintained for 8 hours to distill off the volatile matter. The obtained powder was classified with a sieve having a mesh size of 212 μm to obtain coated negative electrode active material particles (DB-1).

### Production Examples 2-10 to 16: Production of Coated Negative Electrode Active Material Particles (DB-2) to (DB-5), (DB′-1) to (DB′-3)

Coated negative electrode active material particles (DB-2) to (DB-5), (DB′-1) to (DB′-3) were obtained in the same manner as in Production Example 2-9, except that the polymer compound solution for coating (B-1) is changed to (B-2) to (B-5), (B′-1) to (B′-3). The detailed combination are shown in Table 2-2.

### Production Example 2-17: Production of Electrolyte Solution

LiPF₆ was dissolved at a proportion of 1 mol/L in a mixed solvent of ethylene carbonate and propylene carbonate (volume ratio 1:1) to obtain an electrolyte solution for a lithium-ion battery.

### Production Example 2-18: Production of a Current Collector

In a twin-screw extruder, 10 parts of trade name “SunAllomer PB522M” [available from SunAllomer Ltd.], 25 parts of trade name “SunAllomer PM854X” [available from SunAllomer Ltd.], 10 parts of trade name “Suntec B680” [available from Asahi Kasei Chemicals Corporation], 40 parts of graphite particles “SNG-WXA1”, 10 parts of acetylene black 1 “Ensaco 250G” and 5 parts of trade name “Umex 1001 (acid-modified polypropylene)” [available from Sanyo Chemical Industries, Ltd.] were melt-kneaded at 100 rpm at 180° C. with a residence time of 5 minutes to obtain a material for a resin current collector.

The obtained material for a resin current collector was passed through a T-die film extruder, and then rolled by a heat press machine of which the temperature was controlled to 50° C. to obtain a resin current collector.

### Example 2-1

5 g of coated negative electrode active material particles (DB-1) obtained in Production Example 2-9, 0.0505 g of a carbon fiber as a conductive auxiliary agent [Donna Carbo Milled S-242, available from Osaka Gas Chemicals Co., Ltd.] and 0.2632 g of flaky graphite [UP-5-α, available from Nippon Graphite Co., Ltd.] were mixed using a planetary stirring type mixing and kneading device {Awatori Rentaro [THINKY Corporation]} at 1,500 rpm for 3 minutes.

Further, after adding 0.14 g of the electrolytic solution prepared in Production Example 2-17, mixing was carried out twice at 1,500 rpm for 1 minute with Awatori Rentaro and 0.28 g in total of the electrolyte solution was added to obtain a negative electrode composition.

0.055 g of the above-described negative electrode composition was weighed and placed in a cylindrical bottomed container with an inner diameter of 15 mm, and then compressed with a pressurizing device, whereby a negative electrode composition layer (DE-1) formed into a cylindrical shape was obtained.

The pressurizing conditions were a pressurizing pressure of 150 MPa and a pressurizing time of 5 seconds, and the temperature of the pressurizing device (pressurizing jig) was 180° C., which was equal to the room temperature at the time of pressurizing.

### Examples 2-2 to 2-5, Comparative Examples 2-1 to 2-3

Negative electrode composition layers (DE-2) to (DE-5), (DE′-1) to (DE′-3) are prepared in the same way as Example 2-1 except that the coated negative electrode active material particles (DB-1) are changed to coated negative electrode active material particles (DB-2) to (DB-5), (DB′-1) to (DB′-3). The detailed combinations are as shown in Table 2-2.

<Evaluation of Cycle Characteristics>

A PP sheet (available from AS ONE corporation) cut into 2 cm squares was prepared, and a hole of φ18 mm was provided in the center. The prepared negative electrode composition layer (DE-1) and the Li foil cut out to φ15 mm were stored in the hole of φ18 mm provided in the center of the PP sheet with the layer and the foil placed at the poles across a separator made of PP (available from Celgard, LLC), the electrolyte solution was poured to be 110 volume % with respect to the gap of the negative electrode composition layer (DE-1) and the separator, and the resin current collector obtained in Production Example 2-11 and a copper foil cut into 2 cm squares were placed on the outside of each of the negative electrode composition layer (DE-1) and the Li foil. This was heat-sealed under reduced pressure to prepare an evaluation cell.

The evaluation cell was connected to the charging and discharging device, and the cycle characteristics were evaluated under the following conditions.

The charging was carried out with CC-CV (cutoff current 0.01 C) up to 0V at 0.1 C, and after paused for 1 hour, the discharging was carried out up to 1.5V at 0.01 C. The discharge capacity at this time was set to an initial capacity of X₀. This was repeated 30 times to obtain the capacity X₁ of the 30th cycle. The cycle characteristics were evaluated for the cycle characteristics using X₁/X₀ as a 30-cycle discharge capacity retention rate. The evaluation was carried out on the following criteria. The results are described in Table 2-2.

⊚: The discharge capacity retention rate is 80% or more
◯: The discharge capacity retention rate is 70% or more, less than 80%
Δ: The discharge capacity retention rate is 40% or more, less than 70%
x: The discharge capacity retention rate is less than 40%

TABLE 2-2

| | | | Coated | Discharge | |
|---|---|---|---|---|---|
| | | Negative | negative | capacity | |
| | | electrode | electrode | retention | Evaluation |
| | | active | active | rate | of cycle |
| | Polymer | material | material | [% @ | character- |
| | compound | particles | particles | 30 cyc] | istics |
| Examples 2-1 | B-1 | D-1 | DB-1 | 85 | ⊚ |
| Examples 2-2 | B-2 | D-1 | DB-2 | 75 | ◯ |
| Examples 2-3 | B-3 | D-1 | DB-3 | 74 | ◯ |
| Examples 2-4 | B-4 | D-1 | DB-4 | 72 | ◯ |
| Examples 2-5 | B-5 | D-1 | DB-5 | 70 | ◯ |
| Comparative | B′-1 | D-1 | DB′-1 | 40 | Δ |
| Example 2-1 | | | | | |
| Comparative | B′-2 | D-1 | DB′-2 | 40 | Δ |
| Example 2-2 | | | | | |
| Comparative | B′-3 | D-1 | DB′-3 | 10 | X |
| Example 2-3 | | | | | |

The results in Tables 2-2 show that lithium-ion batteries produced using the nagative electrode for a lithium-ion battery is excellent in cycle characteristics.

This specification describes the following technical ideas described in the basic application of this international application.

(1-1) A positive electrode for a lithium-ion battery comprising a current collector and a positive electrode composition layer disposed on a surface of the current collector,

wherein the current collector and the positive electrode composition layer are not adhered to each other,

the positive electrode composition layer contains coated positive electrode active material particles in which at least a part of a surface of each positive electrode active material particle is coated with a coating layer containing a polymer compound (A), and a conductive auxiliary agent,

the polymer compound (A) is any one of:
a copolymer (A1) having methacrylic acid, lauryl methacrylate and 1,6-hexanediol dimethacrylate as constituent monomers,
a copolymer (A2) having isobornyl methacrylate and 1,6-hexanediol dimethacrylate as constituent monomers, or
a copolymer (A3) having lauryl methacrylate, 2-ethylhexyl methacrylate and 1,6-hexanediol dimethacrylate as constituent monomers,

the weight proportion of 1,6-hexanediol dimethacrylate contained in the constituent monomers of the copolymer is 0.2 to 1% by weight based on the total weight of the constituent monomers of the copolymer, and

the weight average molecular weight of the polymer compound (A) is 300,000 or less.

(1-2) The positive electrode for a lithium-ion battery according to (1-1), wherein the thickness of the positive electrode composition layer is 100 to 800 μm.
(1-3) A production method for a positive electrode for a lithium-ion battery comprising a current collector and a positive electrode composition layer disposed on a surface of the current collector, the method comprising the steps of:

preparing a positive electrode composition layer by compression-molding a positive electrode composition containing coated positive electrode active material particles in which at least a part of a surface of each positive electrode active material particle is coated with is coated with a coating layer containing a polymer compound (A), and a conductive auxiliary agent; and

relocating the positive electrode composition layer on the current collector,

wherein the polymer compound (A) is any one of:

a copolymer (A1) having methacrylic acid, lauryl methacrylate and 1,6-hexanediol dimethacrylate as constituent monomers;

a copolymer (A2) having isobornyl methacrylate and 1,6-hexanediol dimethacrylate as constituent monomers; or

a copolymer (A3) having lauryl methacrylate, 2-ethylhexyl methacrylate and 1,6-hexanediol dimethacrylate as constituent monomers, the weight proportion of 1,6-hexanediol dimethacrylate contained in the constituent monomers of the copolymer is 0.2 to 1% by weight based on the total weight of the constituent monomers of the copolymer, and

the weight average molecular weight of the polymer compound (A) is 300,000 or less.

(2-1) A negative electrode for a lithium-ion battery has a current collector and a negative electrode composition layer disposed on a surface of the current collector,

wherein the current collector and the negative electrode composition layer are not adhered to each other;

the negative electrode composition layer contains coated negative electrode active material particles in which at least a part of a surface of each negative electrode active material particle is coated with a coating layer containing a polymer compound (A), and a conductive auxiliary agent;

the polymer compound (B) is a copolymer containing at least one monomer selected from the group consisting of acrylic acid and 2-ethylhexyl methacrylate as an essential constituent monomer; and the total weight ratio of the acrylic acid and the 2-ethylhexyl methacrylate is 60% by weight or more based on the total weight of the constituent monomers of the copolymer.

(2-2) The negative electrode for a lithium-ion battery according to (2-1), wherein the thickness of the negative electrode composition layer is 100 to 900 μm.
(2-3) A production method for a negative electrode for a lithium-ion battery comprising a current collector and a negative electrode composition layer disposed on a surface of the current collector, the method comprising the steps of:

preparing a negative electrode composition layer by compression-molding a negative electrode composition containing coated negative electrode active material particles in which at least a part of a surface of each negative electrode active material particle is coated with is coated with a coating layer containing a polymer compound (A), and a conductive auxiliary agent; and

relocating the negative electrode composition layer on the current collector,

wherein the polymer compound (A) is a copolymer containing at least one monomer selected from the group consisting of acrylic acid and 2-ethylhexyl methacrylate as an essential constituent monomer; and

the total weight ratio of the acrylic acid and the 2-ethylhexyl methacrylate is 60% by weight or more based on the total weight of the constituent monomers of the copolymer.

The polymer compound (A) in (2-1), (2-2) and (2-3) above means the polymer compound (B) in the present specification.

### INDUSTRIAL APPLICABILITY

The positive electrode for a lithium-ion battery of the present invention is particularly useful as a positive electrode for a lithium-ion battery used for mobile phones, personal computers, hybrid vehicles, and electric vehicles.

1. A positive electrode for a lithium-ion battery comprising a current collector and a positive electrode composition layer disposed on a surface of the current collector,
wherein the current collector and the positive electrode composition layer are not adhered to each other,
the positive electrode composition layer contains coated positive electrode active material particles in which at least a part of a surface of each positive electrode active material particle is coated with a coating layer containing a polymer compound (A), and a conductive auxiliary agent,
the polymer compound (A) is any one of:
a copolymer (A1) having methacrylic acid, lauryl methacrylate and 1,6-hexanediol dimethacrylate as constituent monomers,
a copolymer (A2) having isobornyl methacrylate and 1,6-hexanediol dimethacrylate as constituent monomers, or
a copolymer (A3) having lauryl methacrylate, 2-ethylhexyl methacrylate and 1,6-hexanediol dimethacrylate as constituent monomers,
the weight proportion of 1,6-hexanediol dimethacrylate contained in the constituent monomers of the copolymer is 0.2 to 1% by weight based on the total weight of the constituent monomers of the copolymer, and
the weight average molecular weight of the polymer compound (A) is 300,000 or less.

2. The positive electrode for a lithium-ion battery according to claim 1, wherein the thickness of the positive electrode composition layer is 100 to 800 μm.

3. A production method for a positive electrode for a lithium-ion battery comprising a current collector and a positive electrode composition layer disposed on a surface of the current collector, the method comprising the steps of:
preparing a positive electrode composition layer by compression-molding a positive electrode composition containing coated positive electrode active material particles in which at least a part of a surface of each positive electrode active material particle is coated with is coated with a coating layer containing a polymer compound (A), and a conductive auxiliary agent; and
relocating the positive electrode composition layer on the current collector,
wherein the polymer compound (A) is any one of:
a copolymer (A1) having methacrylic acid, lauryl methacrylate and 1,6-hexanediol dimethacrylate as constituent monomers;
a copolymer (A2) having isobornyl methacrylate and 1,6-hexanediol dimethacrylate as constituent monomers; or
a copolymer (A3) having lauryl methacrylate, 2-ethylhexyl methacrylate and 1,6-hexanediol dimethacrylate as constituent monomers,
the weight proportion of 1,6-hexanediol dimethacrylate contained in the constituent monomers of the copolymer is 0.2 to 1% by weight based on the total weight of the constituent monomers of the copolymer, and
the weight average molecular weight of the polymer compound (A) is 300,000 or less.
